(19) United States
(12) Patent Application Publication
(10) Pub. No.: US 2009/0257573 A1
(43) Pub. Date: Oct. 15, 2009

(54) Select ring

(76) Inventor: Timothy Keith Eubank, Austin, TX (US)

Correspondence Address: Timothy Keith Eubank, 1401 Heritage Hill, DeSoto, TX, 75115, US

(21) Appl. No.: 12/082,482

(22) Filed: Apr. 11, 2008

(51) Int. Cl. H04M 11/00

(52) U.S. Cl. 379/93.23

(57) ABSTRACT

Select Ring allows users of communication devices, such as cellular telephones, to designate which incoming calls may transmit voice, video, and/or text data via the device's loudspeaker and display screen while the phone is ringing and before the incoming call is accepted. Select Ring also allows users of communication devices to designate which incoming callers may automatically transmit to the user's phone and receive from the user's phone voice, video, and/or text data via the device's loudspeaker and display screen without requiring the user to manually accept the incoming call.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

This invention applies to communication devices, portable or non-portable, including cellular telephones, home telephones and handheld transceivers. Currently, cellular phones have a caller ID function that displays the phone number of the incoming call and the name of the caller if the number is listed in the phone's contact list. A user can also program certain ring tones or downloaded songs to play while the phone is ringing when a specified caller on the contact list calls the cellular phone. This “prior art” is not as useful to the user as it should be because it does not allow the user more freedom to customize what options should be applied to an incoming call.

Further, answering machines for home phones are insufficient because they allow anyone leaving a message to have their message played via the loudspeaker, rather than only allowing those specified on the contact list to have their message played via the loudspeaker. Handheld transceivers, or walkie-talkies, are insufficient because they do not allow the user to automatically respond or speak simultaneously with the incoming caller. Nor do they record an incoming message. Video messaging via cellular phones is insufficient because these messages are not part of an incoming call. Nor do the contact lists of these phones allow the user to designate which contacts to receive video messages from and which to reject.

To summarize, the current state of the art in communication devices does not allow the user to customize the manner of receiving incoming phone calls and recorded messages.

### BRIEF SUMMARY OF THE INVENTION

The Select Ring allows users of communication devices such as cellular telephones to choose which of their contacts to allow to transmit audio, video, and/or text data through the phone's loudspeaker and display screen as recorded messages while the phone is ringing, rather than merely assigning a specific ringtone or downloaded song to play. This is an improvement over the current art because cellular telephones currently do not allow incoming callers to transmit audio, video, and/or text data in the form of a recorded message through the user's phone via the user's loudspeaker and display screen while the phone is ringing, nor do phones allow the user to select which contact will be allowed to transmit audio, video, and/or text data while the phone is ringing and which contacts may not. The Select Ring also allows users to designate which incoming calls will automatically be answered by the phone without requiring the user to manually accept the incoming call.

### BRIEF DESCRIPTION OF THE SEVERAL VIEWS OF THE DRAWING

FIG. 1 depicts a cellular telephone with a contact's information displayed on the screen. The screen displays the words “Select Ring.” The display shows the options available to the user which include “yes” and “no” for “audio,” “video,” and “text” for both the “Select Ring” function and the “Automatic Answer” function.

FIG. 2 depicts a contact leaving a video message while the phone is ringing.

### DETAILED DESCRIPTION OF THE INVENTION

Select Ring allows users of communication devices to designate which of their contacts can leave audio, video, and/or text messages while the phone is ringing. Select Ring also allows users of communication devices to designate which incoming callers may automatically transmit to the user's phone and receive from the user's phone audio, video, and/or text data via the device's loudspeaker and display screen without requiring the user to manually accept the incoming call.

The process of making the Select Ring is similar to the process for allowing users to select which of their contacts listed in their cellular telephones will cause a specific ringtone or downloaded song to play while the phone is ringing. However, instead of having the user select a ringtone or song, the Select Ring function allows the user to designate which contact can send voice, video, and/or text data through the loudspeaker and display screen of the user's phone while the phone is ringing and before the incoming call has been accepted. The Select Ring function also allows the user to designate which contacts' incoming phone calls will automatically be answered by the user's phone rather than be assigned a specific ringtone or song sample. This is accomplished through adding the Select Ring option to the part of the phone's software that controls the contact list and ringtone preferences.

Select Ring can be used in one of two formats. First, a user of a communication device can allow a specific contact to leave a voice, video, and/or text message played through the phone's loudspeaker and display screen while the phone is ringing and before the incoming call has been accepted. This is termed “the Select Ring function.” Second, a user can allow a call from a specific contact to automatically be answered by the user's phone without requiring the user to manually accept the incoming call. Therefore, when a user receives a phone call from the specific contact, the user's phone will automatically answer the call and transmit audio, visual, and/or text data back to the incoming caller. This feature can be locked into the phone's software by password. This is termed “the Automatic Answer function.”

The Select Ring is distinguishable from other inventions, such as an answering machine, handheld transceiver, or video message-capable cellular telephone.

Some answering machines play through the loudspeaker the message being recorded. However, the user cannot designate which incoming calls to broadcast and which to record silently. These answering machines do not contain contact lists. Further, these answering machines do not work with cellular phones, nor do they allow the user to automatically answer an incoming call from a specified contact. The user must pick up the phone to accept the incoming call and begin a conversation.

Handheld transceivers, or walkie-talkies, are distinguishable because they do not contain contact lists. Third parties on the same frequency may converse with the user and the incoming caller. Further, a simultaneous conversation cannot take place because only one person at a time may communicate. Also, the transceiver does not record the message from the incoming caller as the Select Ring does.

Video messaging is distinguishable because video messaging does not allow the user to accept an incoming call and carry on a conversation with the caller. Nor do phones with video message capability allow the user to designate which messages to receive and which to reject.

The specific improvement to the machine, a communication device, is a function that allows a caller designated in the user's contact list to speak and send visual images and text to the user's communication device which are played through the loudspeaker and displayed on the video screen before the call has been accepted and while the phone is recording the message. This is an improvement over the prior art of distinguishing incoming calls by ringtones or song samples.

The next specific improvement to a communication device is a function that allows a user to designate which contacts may automatically have their call answered by the communication device, including receiving audio, visual, and text data, rather than requiring the user to manually accept the incoming call by pressing a button or speaking a voice command.

The parts of a communication device that necessarily cooperate with the Select Ring are the loudspeaker, microphone, display screen, camera, keypad, contact list, and software.

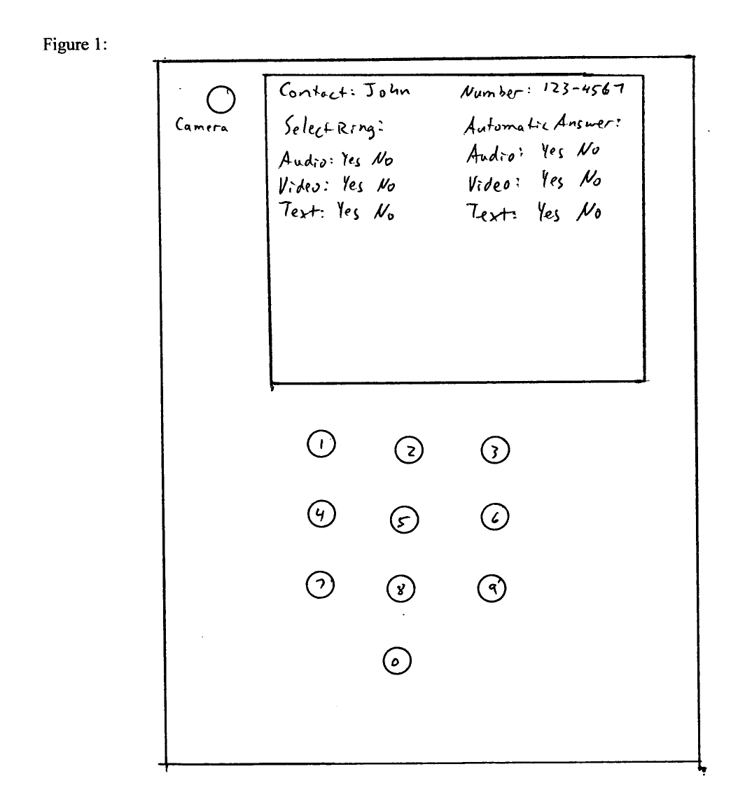

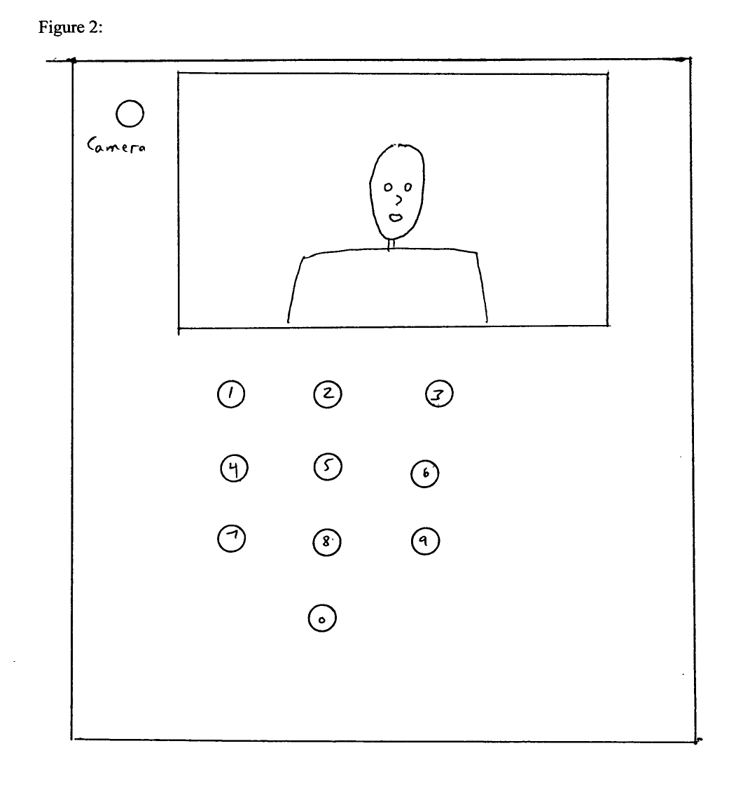

The best mode of carrying out the invention requires adding a function to the device's contact list that will have the options presented in FIG. 1. For any contact, the user will be able to select “yes” or “no” to “audio,” “video,” and “text” under the “Select Ring” function, as well as “yes” or “no” to “audio,” “video,” and “text” under the “Automatic Answer” function. Selecting “yes” to “audio” under the Select Ring option allows an incoming caller to speak through the user's loudspeaker while the phone is ringing before the user has accepted the incoming call. Selecting “yes” to “video” under the Select Ring option allows an incoming caller to display video images on the display screen of the user's phone while the phone is ringing, as depicted in FIG. 2. Selecting “yes” to “text” under the Select Ring option allows an incoming caller to send text typed through the caller's keypad to the user's display screen while the phone is ringing before the user has accepted the incoming call. The Select Ring function can be locked into the phone so that it can only be changed by authorized access via password.

Selecting “yes” to “audio” under the Automatic Answer option will automatically initiate the conversation between the incoming caller and the user without requiring the user to accept the incoming call. Selecting “yes” to “video” under the Automatic Answer option automatically allows images to be displayed between the user's and incoming caller's phones without requiring the user to accept the call. Selecting “yes” to “text” under the Automatic Answer option automatically allows text typed on the caller's keypad and the user's keypad to be displayed as it is typed between the user's and incoming caller's phones without requiring the user to accept the call. The Automatic Answer function can be locked into the phone so that it can only be changed by authorized access via password.

An example of a possible use of the Select Ring function is described in the following lines. John owns a cellular telephone with a list of contacts identified by the telephone number of the incoming caller or text messenger. John has saved the information of family and friends in his cell phone's contact list by entering information such as their name and the type of communication device associated with the phone number, such as work phone or home phone. John uses the Select Ring option to allow his wife, Elizabeth, to speak into her phone while John's phone is ringing and before he has accepted the call. John has selected “yes” next to “audio” under the Select Ring function under Elizabeth's contact information as contained on John's cellular telephone's software and memory. Rather than John's phone making a ringing sound, Elizabeth's voice is projected via the loudspeaker on John's phone. Elizabeth speaks the words “I need to speak with you” into her phone and these words are projected from the loudspeaker on John's phone. The words are also recorded on John's phone as a recorded message that he can later listen to. In this case, while Elizabeth is speaking, John presses the send button on his phone to accept Elizabeth's incoming call. John says “What would you like to speak about?” These words are transmitted to Elizabeth's phone and the conversation is continued.

An example of a possible use of the Automatic Answer function is described in the following lines. Elizabeth owns a cellular telephone that she allows her daughter, Lauren, to use. Elizabeth has entered the phone number of Elizabeth's work phone into Lauren's phone. Under Elizabeth's work phone contact information that is contained in the software and memory on Lauren's phone, Elizabeth has selected “yes” to “audio” and “video.” Elizabeth has saved this information via a password so that no unauthorized person can change the settings. While Elizabeth is at work and Lauren is at the library studying, Elizabeth calls Lauren's phone from Elizabeth's work phone. Lauren's phone automatically accepts the incoming call from Elizabeth's work phone and voice and image data are transferred between the two phones. Immediately, Elizabeth can hear sounds picked up from the microphone on Lauren's phone that are projected via the loudspeaker on Elizabeth's work phone. Elizabeth can also see images captured through the camera on Lauren's phone that are displayed on the display screen on Elizabeth's work phone. Elizabeth can hear and see that her daughter is studying at the library.

Another example of a possible use of the Automatic Answer function is described in the following lines. Elizabeth owns a cellular telephone that she allows her daughter, Lauren, to use. Elizabeth has entered the phone number of Elizabeth's work phone into Lauren's phone. Under Elizabeth's work phone contact information that is contained in the software and memory on Lauren's phone, Elizabeth has selected “yes” to “text” for the Automatic Answer function. Elizabeth has saved this information via a password so that no unauthorized person can change the settings. While Elizabeth is at work and Lauren is at the library studying, Elizabeth types the text “love you,” into Elizabeth's keypad and the text is immediately displayed on Lauren's phone one letter at a time as Elizabeth types it. Lauren types the text “love you too,” on the keypad on Lauren's phone, and the text is displayed letter by letter on the display screen of Elizabeth's phone as it is being typed.

1. A function that allows a user of a communication device to designate which incoming calls from specified phone numbers, or contacts, may transmit audio, video, or text data, or a combination thereof, via the device's loudspeaker and display screen as a recorded message while the device is ringing and before the user has accepted the incoming call to initiate a conversation.

2. A function that allows a user of a communication device to designate which incoming calls from specified phone numbers, or contacts, may automatically transmit to and receive from the user's device audio, video, or text data, or a combination thereof, via the device's loudspeaker and display screen without requiring the user to manually accept the incoming call.
